(19) United States
(12) Patent Application Publication
(10) Pub. No.: US 2011/0063722 A1
(43) Pub. Date: Mar. 17, 2011

(54) STACKED DISK-SHAPED OPTICAL LENS ARRAY, STACKED LENS MODULE AND METHOD OF MANUFACTURING THE SAME

(76) Inventors: San- Woei SHYU, Taipei (TW); Huang- Chang Chen, Taipei (TW); Chih- Peng Wang, Taipei (TW); Te- Cheng Lin, Taipei (TW)

(21) Appl. No.: 12/880,909

(22) Filed: Sep. 13, 2010

(30) Foreign Application Priority Data
Sep. 11, 2009 (TW) 098130845

(51) Int. Cl. G02B 13/14; G02B 27/10; B32B 37/24

(52) U.S. Cl. 359/355; 359/619; 156/242

(57) ABSTRACT

A stacked disk-shaped optical lens array, a stacked lens module and a method of manufacturing the same are revealed. The stacked disk-shaped optical lens array is produced by at least tow disk-shaped optical lens arrays whose optical axes are aligned. After the optical axes of the stacked disk-shaped optical lens array being aligned by alignment fixtures, the stacked disk-shaped optical lens array is cut to produce a single stacked optical lens element. The optical lens element and optical elements required are mounted into a lens holder to form the stacked lens module. The stacked lens module produced by the method has optical lens elements whose axes are aligned precisely. The processes for manufacturing lens modules are simplified and the cost is reduced.

### BACKGROUND OF THE INVENTION

The present invention relates to a stacked disk-shaped optical lens array, a stacked lens module and methods of manufacturing the same, especially to a stacked disk-shaped optical lens array formed by stacking at least two disk-shaped optical lens arrays.

The resin injection-compression molding technology has been widely applied to various optical produces with high requirements of precision, size and optical properties such as DVD, CD-ROM, or optical lenses. The resin injection-compression molding combines two techniques-injection molding and compression molding. A mold compression process is added into general injection molding processes. That means during the beginning of the resin casting process, the mold is not closed completely. The mold is closed by pressure after part of resin being filled into a mold cavity. The pressure is applied to melt resin material inside the mold cavity through the casting area. The processes are called “closing and clamping mold operations” and the mold cavity filling is finished by compression molding. Compared with injection molding, the residual stress is reduced, the difference in refractive index is decreased, and the optical lens element is with higher accuracy. As shown in US2008/0093756, JP2008-230005, JP2003-071874 etc., optical lens elements are produced by such molding method.

Optical lenses have been broadly used in optical systems such as optical lenses of camera phones. While assembling optical lenses or producing optical lenses, a plurality of optical lens elements with different refractions is assembled with certain air spacing for images. Thus optical axis of each optical lens element needs to be aligned precisely so as to prevent reduced resolution. Moreover, there is a certain distance arranged between the optical lens elements. It takes a lot of time and efforts to run processes and precise alignment. Thus the production can't be boosted and the cost can't be reduced. Especially the assembling of the optical lens array will influence the optical effects once the optical axis of the optical lens array is not aligned. Thus the alignment of the optical lens array is getting more important and more complicated. JP2001194508 disclosed a method for manufacturing plastic optical lens array. TW M343166 revealed a method for manufacturing glass optical lens array. After production of the optical lens array, it can be cut and divided into a single optical lens element that is used in a lens module. Or the optical lens array is assembled with other optical elements to form a lens submodule array that is divided into a single lens submodule. The lens submodule is assembled with a lens holder, an image capture device or other optical elements to form a lens module.

In manufacturing lens module arrays, U.S. Pat. No. 7,183,643, US2007/0070511, WO2008011003 etc revealed a wafer level lens module. Refer to FIG. 1, an ordinary optical lens module array includes an aperture 911, a cover glass 912, a plurality of optical lens elements and an IR cut lens 917. As shown in figure, it is a three-piece type optical lens set includes a first optical lens element, a second optical lens element and a third optical lens element 914, 915, 916, spaced by a spacer 913. After assembly, a lens module array is produced and lens modules are generated after cutting the lens module array. Refer to FIG. 2 and FIG. 3, US2006/0044450 disclosed a wafer level lens module 9100. Each lens substrate 918 is arranged with an optical lens array 914, 915 respectively and separated by a spacer 913 so as to form an arrayed optical lens module 900. Cut the arrayed optical lens module 900 to produce a single optical lens module 9100.

However, while assembling several optical lens arrays for producing lens module arrays, alignment of each optical lens array has effects on resolution of the lens module array. Refer to US2006/0249859, it revealed fiducial marks generated by infrared rays to assemble wafer level lens module. Refer to JP2000-321526, and JP2000-227505, a SELFOC lenses array is produced by assembling of height with cervice. Refer to JP2001-042104, recesses with different depth are used to prevent warpage and deformation of the micro lens array. As to U.S. Pat. No. 7,187,501, cone-shaped projection is used to stack multiple optical lens elements and produce a plastic optical lens array.

The optical lens module array used in lens assemblies of LED (light emitting diode) light sources, lens assemblies of solar energy systems, and lens modules of mobile cameras generally includes a plurality of optical lens arrays with different optical surfaces. In conventional plastic optical lens arrays assembled by projections and holes, the plastic optical lens arrays are produced by injection molding, the size of the projections and holes may change due to material shrinkage. Thus the alignment accuracy is difficult to be improved. And the optical axis of each optical lens in the plastic optical lens array is shifted and difficult to be aligned. This results in restrictions on use.

A disk-shaped optical lens array produced by resin injection-compression molding and resin casting process through a center of a disk has low inner stress and high accuracy. Moreover, a disk hole arranged at a center of the disk-shaped optical lens array is used for alignment while assembling. Thus an easy method of manufacturing an optical lens module array with high accuracy by the disk-shaped optical lens array is provided. The produced optical lens module array is used in optical lenses of phone cameras, matching requirements of yield rate and production of mass production.

### SUMMARY OF THE INVENTION

Therefore it is a primary object of the present invention to provide a stacked disk-shaped optical lens array applied to optical lenses of optical systems such as camera lenses, mobile phone lenses, or a single LED optical lens.

In order to achieve above object, a stacked disk-shaped optical lens array of the present invention includes at least two disk-shaped optical lens arrays stacked and assembled by glue with a preset interval. The disk-shaped optical lens array produced by resin injection-compression molding is a round disk with a disk hole at a center thereof, but not limited to the round shape. The disk-shaped optical lens array includes a first optical surface and a second optical surface, respectively with corresponding optical divisions and non-optical divisions. The optical divisions of the first optical surface and of the second optical surface form a plurality of optical lens elements arranged in an array. At least one glue groove is disposed on a periphery of the non-optical division of at least one disk-shaped optical lens array. After the glue in the glue groove being cured, the two adjacent disk-shaped optical lens arrays are fixed and connected with each other to form a stacked disk-shaped optical lens array. Moreover, at least one alignment fixture is disposed on a periphery of the non-optical division of at least one disk-shaped optical lens array. By the alignment fixture, the two adjacent disk-shaped optical lens arrays are stacked and assembled precisely and optical axis of each optical lens element is aligned. Furthermore, the stacked disk-shaped optical lens array is coated with glue on the non-optical division so as to be assembled with other optical element arrays in a stacked way. The optical element array is an array formed by optical lenses, spacers, apertures, cover glasses, IR-cut glasses etc. After being cut, the stacked disk-shaped optical lens array is divided into a plurality of single stacked optical lens elements.

It is another object of the present invention to provide a stacked disk-shaped optical lens array applied to optical lenses of optical systems while the stacked disk-shaped optical lens array includes at least two disk-shaped optical lens arrays fixed and assembled by glue with a present interval. The disk-shaped optical lens array produced by resin injection-compression molding is a round disk with a disk hole at a center thereof, but not limited to the round shape. The disk hole of at least one disk-shaped optical lens array is disposed with a guiding structure by which the two disk-shaped optical lens arrays are stacked and assembled. Moreover, a spacer is arranged between two disk-shaped optical lens arrays to have designed air spacing. The spacer is fixed and assembled with adjacent disk-shaped optical lens array by glue.

It is a further object of the present invention to provide a stacked lens module. The stacked lens module consists of at least one stacked optical lens element, a lens holder and at least one optical element. The stacked optical lens element is produced by cutting a stacked disk-shaped optical lens array and dividing a single element from the stacked disk-shaped optical lens array. The optical element includes an optical lens, a spacer, an aperture, a cover glass, an IR-cut glass, etc.

It is a further object of the present invention to provide a method of manufacturing a stacked disk-shaped optical lens array and a stacked lens module including following steps:
S1: providing an injection-compression mold having an upper mold and a lower mold respectively with optical molding surfaces; the upper mold and/or the lower mold is disposed with an alignment fixture molding surface respectively and a material inlet is arranged at a center of the upper mold or the lower mold;
S2: producing a primary product of a disk-shaped optical lens array by resin injection-compression molding and cutting off a down sprue stick of the primary product of a disk-shaped optical lens array to produce a disk-shaped optical lens array; the disk-shaped optical lens array includes a plurality of optical lens elements formed on optical division while non-optical division of the disk-shaped optical lens array is arranged with glue grooves and alignment fixtures;
S3: producing another disk-shaped optical lens array by the above steps and this disk-shaped optical lens array can be without the glue groove;
S4: coating glue on the glue groove of two adjacent disk-shaped optical lens arrays and then stack and assemble the two disk-shaped optical lens arrays by guiding structures;
S5: aligning optical axes of two adjacent disk-shaped optical lens arrays by the alignment fixtures so that the optical axes are aligned with optical center;
S6: curing the glue to form a stacked disk-shaped optical lens array; thereby at least two disk-shaped optical lens arrays are assembled precisely to form a stacked disk-shaped optical lens array whose optical center is aligned precisely;
S7: coating non-optical division of the stacked disk-shaped optical lens array with glue for being assembled and stacked with other optical element arrays so as to form a stacked disk-shaped optical lens array with the optical element arrays after curing of the glue;
S8: cutting the stacked disk-shaped optical lens array so as to obtain a single stacked optical lens element;
S9: mounting the stacked optical lens element into a lens holder to be assembled with other optical elements so as to form a stacked lens module.

According to the present method, precise stacked optical lens arrays and stacked lens modules are produced at a time. Thus precise assemblies are obtained and mass production is achieved.

### BRIEF DESCRIPTION OF THE DRAWINGS

FIG. 1 is a schematic drawing showing a conventional stacked optical lens array;

FIG. 2 is a schematic drawing showing another conventional stacked optical lens array;

FIG. 3 is a schematic drawing showing a further conventional stacked optical lens array;

FIG. 4 is a schematic drawing showing an embodiment of a disk-shaped optical lens array according to the present invention;

FIG. 5 is a schematic drawing showing an embodiment of a disk-shaped optical lens array with alignment pins and alignment cavities according to the present invention;

FIG. 6 is a schematic drawing showing an embodiment of a disk-shaped optical lens array with collimating lenses and a guiding notch according to the present invention;

FIG. 7 is a schematic drawing showing an embodiment of a disk-shaped optical lens array with reticles, through holes and a guiding angle according to the present invention;

FIG. 8 is a schematic drawing showing an embodiment of a disk-shaped optical lens array with glue grooves according to the present invention;

FIG. 9 is a schematic drawing showing assembling of an embodiment of a disk-shaped optical lens array according to the present invention;

FIG. 10 is a schematic drawing showing a further embodiment of a disk-shaped optical lens array according to the present invention;

FIG. 11 is a schematic drawing showing a further embodiment of a disk-shaped optical lens array according to the present invention;

FIG. 12 is a schematic drawing showing an embodiment of a disk-shaped optical lens array in which optical axes are aligned by collimating lenses according to the present invention;

FIG. 13 is a schematic drawing showing a flow chart of manufacturing a disk-shaped optical lens array and a stacked lens module according to the present invention;

FIG. 14 is a schematic drawing showing an embodiment of a stacked lens module according to the present invention;

FIG. 15 is a schematic drawing showing another embodiment of a stacked lens module according to the present invention.

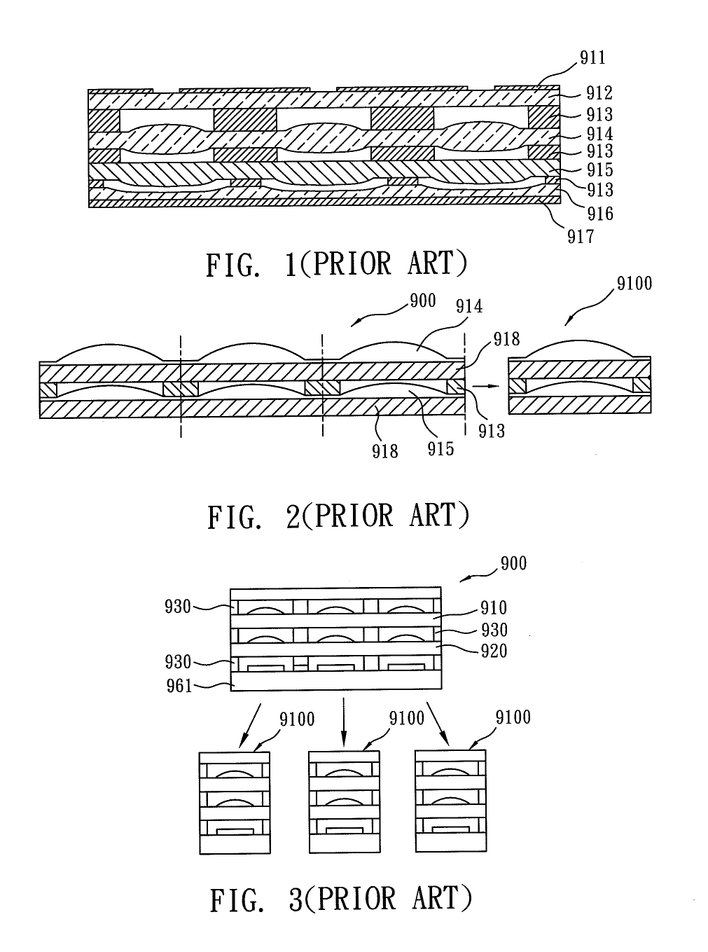

### DETAILED DESCRIPTION OF THE PREFERRED EMBODIMENT

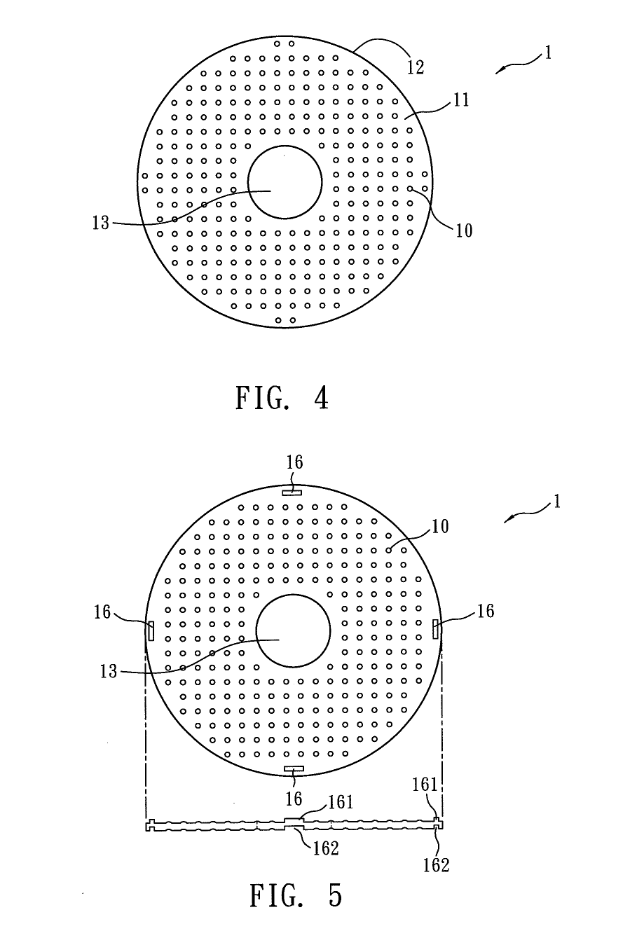

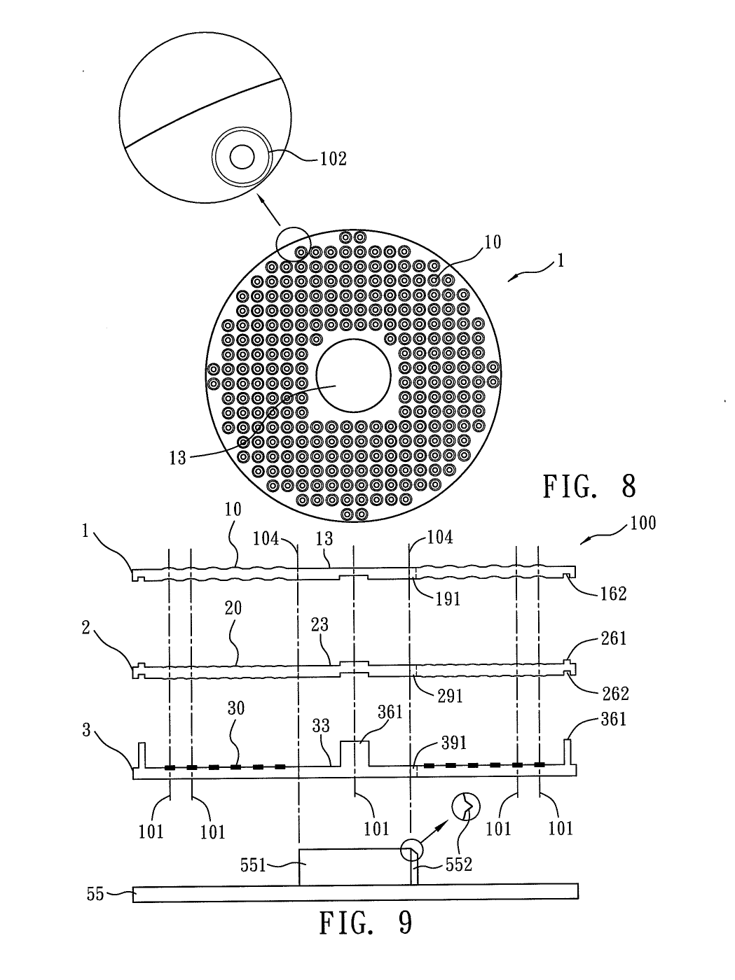

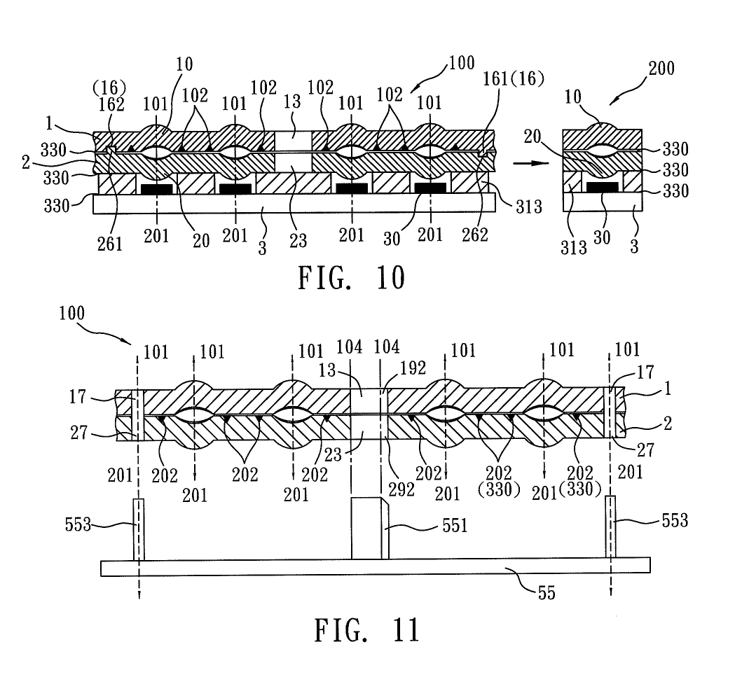

Refer to FIG. 10, a stacked disk-shaped optical lens array 100 of the present invention includes at least two disk-shaped optical lens arrays 1, 2 fixed and assembled at a preset interval by glue. The disk-shaped optical lens arrays 1 (2) is a round disk with a disk hole 13 (23) on a center thereof produced by resin injection-compression molding, as shown in FIG. 4. The disk-shaped optical lens arrays 1 (2) includes a first optical surface 11 (21) and a second optical surface 12 (22), respectively having optical area and non-optical area. The optical area of the first optical surface 11 (21) and of the second optical surface 12 (22) are corresponding to each other to form a plurality of optical lens elements 10 (20) arranged in an array. At least one glue groove 102 is disposed on a periphery of the non-optical area of at least one disk-shaped optical lens array 1 (2), as shown in FIG. 8. After glue 330 filled in the glue groove 102 curing, the two disk-shaped optical lens arrays 1, 2 are connected and fixed to form a stacked disk-shaped optical lens array 100. Moreover, at least one alignment fixture 16 (15, 17, 18) is arranged at a peripheral of the non-optical area of at least one disk-shaped optical lens arrays 1 (2), as shown from FIG. 5 to FIG. 7. The disk-shaped optical lens arrays 1, 2 are stacked and assembled precisely by the alignment fixture 16 (15, 17, 18) so that an optical axis 101 of each optical lens element 10 are aligned. Furthermore, the shaped of the disk-shaped optical lens array 1(2) is not limited, it can be a round disk or a square disk or other shape according to users' need or designs of resin injection-compression molding molds.

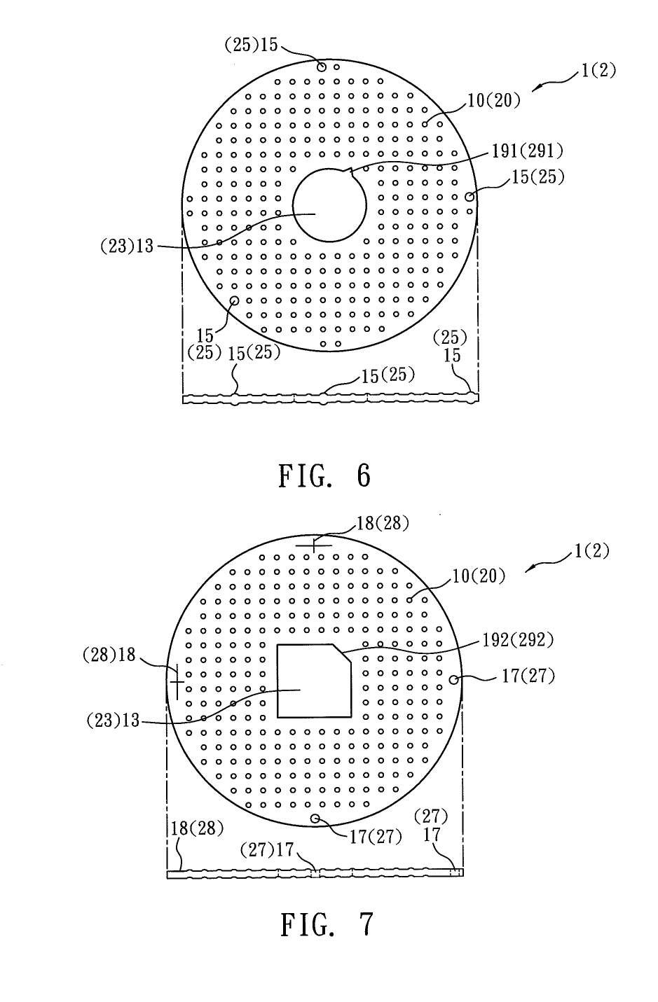

In order to located the two disk-shaped optical lens arrays 1, 2 quickly while stacking and assembling, a guiding structure 191 (291) is disposed on the disk hole 13 (23), as a notch structure shown in FIG. 6. Or the disk hole 13 (23) is polygonal and one corner of the disk hole 13 (23) is cut to use as a guiding structure 191 (291), as shown as an angle structure in FIG. 7.

The shape and the type of the glue groove 102 are not limited to round grooves, as shown in FIG. 8. Refer from FIG. 5 to FIG. 7 the shape and type of the alignment fixture 16(15-17-18) are not limited to an alignment pin 161, an alignment cavity 162, a collimating lens 15, a through hole 17 or a reticle 18 etc. The optical lens element is not restricted in optical lenses, spacers, apertures, cover glasses, infra-red (IR) cur glasses, image capture devices, photoelectric devices, printed circuit boards (PCB) etc. Similarly, the guiding structure is not limited to the guiding notch 191(291), the guiding angle 191(291), or polygonal hole.

Refer to FIG. 10, the stacked disk-shaped optical lens array 100 is glued and stacked with other optical element array 3 on the non-optical area. The optical element array 3 is an array formed by optical lenses, spacers, apertures, cover glasses, IR-cut glasses, etc.

The stacked disk-shaped optical lens array 100 is singularized into a plurality of single stacked optical lens elements 200 by cutting.

Refer to FIG. 13, a method of manufacturing a stacked disk-shaped optical lens array of the present invention includes following steps:
S1: providing an injection-compression mold 51 having an upper mold 511 and a lower mold 512 respectively with an upper mold core 513 and a lower mold core 514 as well as corresponding optical molding surfaces so as to form a plurality of optical lens elements 10; the upper mold core 513 and/or the lower mold core 514 is disposed with an alignment fixture molding surfaces 5132, 5142 respectively and a material inlet 521 is arranged at a center of the upper mold 511 or the lower mold 512;
S2: producing a primary product of a disk-shaped optical lens array 61 by resin injection-compression molding and cutting off a down sprue stick 614 of the primary product of a disk-shaped optical lens array 61 to produce a disk-shaped optical lens array 1 with a disk hole 13 and a guiding structure 191(192); a non-optical area of the disk-shaped optical lens array 1 is arranged with glue grooves and/or alignment fixtures 161;
S3: producing another disk-shaped optical lens array 2 by the above steps and the disk-shaped optical lens array 2 can be without the glue groove 102;
S4: coating glue 330 on the glue groove 102 of two adjacent disk-shaped optical lens arrays 1, 2 and then stack and assemble the two disk-shaped optical lens arrays 1, 2 by guiding structures 191(192), 291 (292);
S5: aligning optical axes 101 of two adjacent disk-shaped optical lens arrays 1, 2 by the corresponding alignment fixtures 161(162), 262(261) so that each optical lens element 10, 20 is aligned with optical center;
S6: curing the glue 330 to form a stacked disk-shaped optical lens array 100;
S7: coating non-optical division of the stacked disk-shaped optical lens array 100 with glue for being assembled and stacked with other optical element arrays 3, 313 so as to form a stacked disk-shaped optical lens array 100 with the optical element arrays 3, 313 after curing of the glue 330;
S8: cutting and dividing the stacked disk-shaped optical lens array 100 to get a single stacked optical lens element 200;

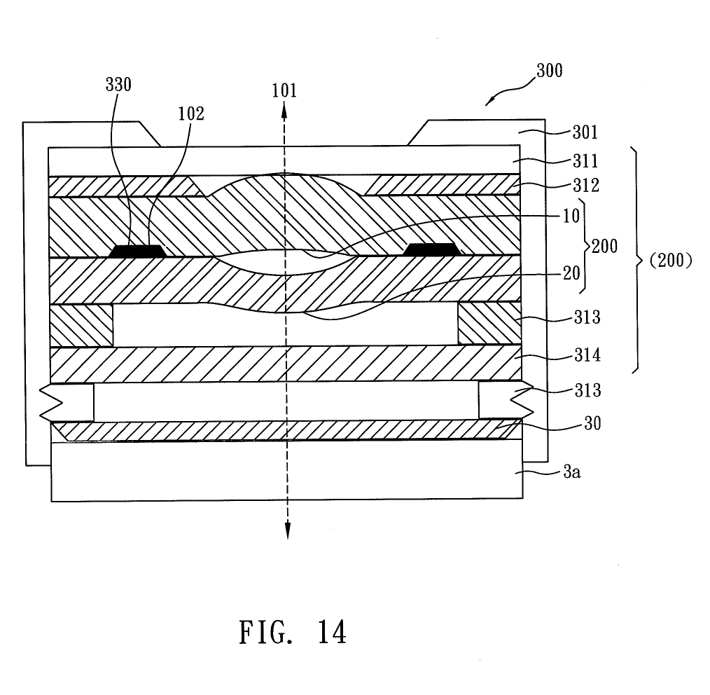

A method of manufacturing a stacked lens module consists of following steps:
SS1: producing a stacked disk-shaped optical lens array 100 by the step S1 to S6 for manufacturing the stacked disk-shaped optical lens array mentioned above;
SS2: cutting the stacked disk-shaped optical lens array 100 to get a single stacked optical lens elements 200;
SS3: mounting the stacked optical lens elements 200 into a lens holder 301 and assembled with required optical elements such as cover glasses 311, apertures 312, spacers 313, IR cut glasses 314, and circuit boards 3 with image capture devices 30 so as to form a stacked lens module 300, as shown in FIG. 14.

### Embodiment 1

Refer to FIG. 5, FIG. 8, FIG. 9, FIG. 10, FIG. 13, this embodiment is a stacked disk-shaped optical lens array 100 with an alignment fixture 16, having a first and a second disk-shaped optical lens arrays 1, 2. A primary product 61 of disk-shaped optical lens arrays is produced by a resin injection-compression molding and then a down sprue stick 614 of the primary product 61 is cut off to form a central disk hole 13 (23). Thus the first and the second disk-shaped optical lens arrays 1, 2 are formed.

The first disk-shaped optical lens array 1 is a round disk with a diameter of 120 mm, having a disk hole 13 on a center thereof, a first and a second optical surfaces 11, 12 with corresponding 244 optical divisions arranged at equal intervals in an array respectively. The diameter of the disk hole 13 is 30 mm. Each optical division forms a meniscus optical lens element 10. Non-optical division on a peripheral of each optical lens element 10 is disposed with a glue groove 102, as shown in FIG. 8. Moreover, Non-optical division on a peripheral of the first disk-shaped optical lens array 1 is disposed with two alignment pins 161 and two alignment cavities 162 respectively separated by 90 degrees (one-quarter of a cycle) and used as alignment fixtures. The alignment pins 161 and the alignment cavities 162 are parallel to the optical axes 101 and located on preset positions, as shown in FIG. 5. In different embodiments, the alignment pin 161 and the alignment cavity 162 can be other types or arranged at different positions.

The second disk-shaped optical lens array 2 is produced by the same method and having 244 meniscus optical lens elements 10 corresponding to the optical lens elements 10 of the first disk-shaped optical lens array 1. The second disk-shaped optical lens array 2 can be without the glue groove 102. Moreover, its non-optical division on the peripheral is arranged with two alignment cavities 262 and two alignment pins 261 as alignment fixtures, respectively corresponding to the alignment pins 161 and the alignment cavities 162 of the first disk-shaped optical lens array 1.

Refer to the steps S4, S5, and S6, while stacking and assembling the first disk-shaped optical lens array 1 and the second disk-shaped optical lens array 2, use a dispensing system (glue dispenser) to coat glue 330 over the glue groove 102 of the first disk-shaped optical lens array 1. The materials of the glue 330 are not limited but thermosetting glue or UV glue is preferred for optical systems. In this embodiment, thermosetting glue is used. Then by the alignment fixtures between the two disk-shaped optical lens arrays 1, 2 connecting with each other such as the alignment pins 161 and the alignment cavities connecting with the corresponding alignment cavities 262 and the alignment pins 261 respectively, the optical axis 101, 201 of each optical lens element 10, 20 are aligned after being stacked and assembled so as to form a stacked disk-shaped optical lens array 100 having two sets of 244 meniscus optical lens elements 10, 20 assembled precisely.

Refer to FIG. 10, the stacked disk-shaped optical lens array 100 is further stacked with an optical element array 3. In this embodiment, an optical lens array 100 consists of the stacked optical lens array (100) formed by the first and the second disk-shaped optical lens arrays 1, 2, an optical element array 3 and a spacer array 313. The optical element array 3 is formed by a number of 244 optical elements 30 (such as image capture devices 30) arranged in an array and located on a disk-shaped substrate (such as a circuit board). Each optical element 30 is corresponding to each optical lens element 10, 20. The spacer array 313 is produced by an opaque plastic plate with a certain thickness and having 244 through holes. The spacer array 313 keeps designed air spacing between the optical lens element 20 and the optical element 30. While being stacked and assembled, the first and the second disk-shaped optical lens arrays 1, 2 are firstly stacked to form a stacked disk-shaped optical lens array (100). Then coat glue 330 on two surfaces of the spacer array 313 or coat glue 330 on a surface of the stacked disk-shaped optical lens array and a surface of the optical element array 3 that are facing each other. Then the stacked disk-shaped optical lens array, the spacer array 313 and the optical element array 3 are stacked in turn. The optical element array 3 and the optical axis 101 are aligned. After the glue 330 being cured in an oven, a stacked disk-shaped optical lens array 100 with 244 optical lenses is produced.

Refer to FIG. 9, another stacking way of the embodiment is revealed. The non-optical division of the optical element array 3 is disposed with four alignment pins 361 used as alignment fixtures while the first and the second disk-shaped optical lens array 1, 2 respectively is arranged with a guiding structure 191, 291. As shown in FIG. 6, a guiding structure 191 in the form of a guiding notch is disclosed. The disk hole 13 (23) and the guiding structure 191 (291) are formed by cutting the down sprue stick 614 of the primary product 61 of disk-shaped optical lens arrays. The diameter of the disk hole 13 (23) is 30 mm and the distance from an apex angle to the periphery of the disk hole 13 (23) is 0.8 mm. The second disk-shaped optical lens array 2 is disposed with four alignment cavities 262 used as alignment fixtures that are corresponding to and assembled with the alignment pins 361 of the optical element array 3. Moreover, the height of the alignment pin 361 is pre-designed so that designed air spacing between each optical lens element 20 of the second disk-shaped optical lens array 2 and each image capture device 30 of the optical element array 3 is maintained after the alignment pins 361 being assembled with the alignment cavities 262.

Refer to FIG. 9, while stacking and assembling, the non-optical divisions of the first and the second disk-shaped optical lens arrays 1, 2 and the optical element array 3 are coated with glue 330 and then are set into an assembly fixture 55. The assembly fixture 55 is disposed with a disk-hole assembly pole 551 which is with a disk-hole alignment cam 552 so as to correspond and assemble with the guiding structure 191(291-391) of the disk hole 13(23-33) of the optical element array 3. By the disk-hole assembly pole 551 and the disk-hole alignment cam 552 of the assembly fixture 55, the first and the second disk-shaped optical lens arrays 1, 2 and the optical element array 3 are initially aligned along a disk hole guiding line 104 and this favors following precise alignment. Thus the assembling time is shortened and the assembling efficiency is improved.

For precise alignment, the first and the second disk-shaped optical lens arrays 1, 2 and the optical element array 3 are aligned and assembled by alignment fixtures 162, 261, 262, 361 so that optical axes 101 of each optical lens element 10, 20 and each image capture device 30 are aligned. After the glue 330 being cured in an oven, a stacked disk-shaped optical lens array 100 with 244 optical lens elements is produced.

### Embodiment 2

Refer to FIG. 6, FIG. 12, a stacked disk-shaped optical lens array 100 of this embodiment includes an alignment fixture 15(25) that is a collimating lens, a disk hole 13(23) arranged with a guiding structure 191 (291) (guiding notch), a first disk-shaped optical lens array 1 and a second disk-shaped optical lens array 2.

The first and the second disk-shaped optical lens arrays 1, 2 produced by the same method in the embodiment one respectively include 249 meniscus lens elements 10 and 249 bi-convex lens elements 20 arranged at equal intervals and the optical lens elements 10, 20 are corresponding to each other. The optical axes 101, 201 of the optical lens elements 10, 20 are aligned and arranged with an equal interval.

The first and the second disk-shaped optical lens arrays 1, 2 are round disks with a diameter of 120mm, each having a disk hole 13, 23 on a center thereof, and a notch-type guiding structure 191, 291. The disk hole 13, 23 and the guiding structure 191, 291 are formed by removing a down sprue stick 614 from a primary product of a disk-shaped optical lens array 61. The diameter of the disk hole 13, 23 is 30 mm and the distance between the apex angle of the guiding structure 191, 291 and the peripheral of the disk hole 13, 23 is 0.8 mm. Moreover, non-optical division on the peripheral of each optical lens element 10, 20 is arranged with a glue groove 102, 202. Three collimating lens type alignment fixtures 15 such as a bi-convex or plano-convex spherical lens element are arranged at 120 degrees around the periphery of the disk-shaped optical lens array. When laser beam passes through the collimating lens (15), it becomes a light beam parallel to the optical axis for calibration. A spacer array 313 is arranged between the first and the second disk-shaped optical lens arrays 1, 2 so as to have designed air spacing between each optical lens element 10 and each optical lens element 20.

While assembling and stacking, the glue grooves 102, 202 of the first and the second disk-shaped optical lens arrays 1, 2 are coated with glue 330 such as UV glue. Then the first disk-shaped optical lens array 1, the spacer array 313 and the second disk-shaped optical lens array 2 are put into an assembly fixture 55 for initial alignment as shown in FIG. 9. The first and the second disk-shaped optical lens arrays 1, 2 and the optical element array 3 are initially aligned along a disk hole guiding line 104 by the disk-hole assembly pole 551 and the disk-hole alignment cam 552 of the assembly fixture 55.

For precise alignment, refer to FIG. 12, a laser alignment system 57 emits a laser beam 571 passing through the collimating lens type alignment fixtures 15, 25 of the first and the second disk-shaped optical lens arrays 1, 2. Then adjust the first and the second disk-shaped optical lens arrays 1, 2 so as to make optical axes 101, 201 of each optical lens element 10, 20 align with each other. That means align with the optical axis 101. Then the glue 330 is cured under UV radiation. After being removed from the assembly fixture 55, a stacked disk-shaped optical lens array 100 with 249 optical lens sets is produced. The optical lens set includes a meniscus lens element, a spacer, and a bi-convex lens element assembled precisely.

### Embodiment 3

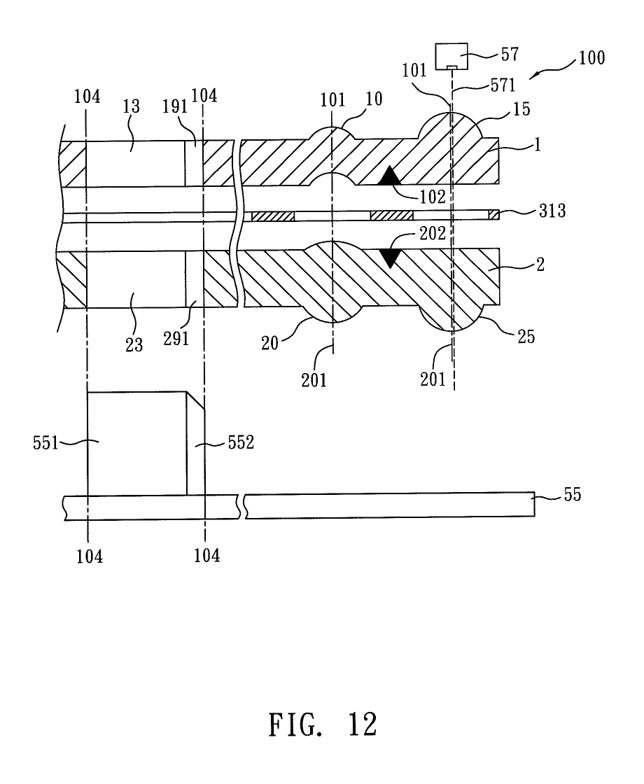

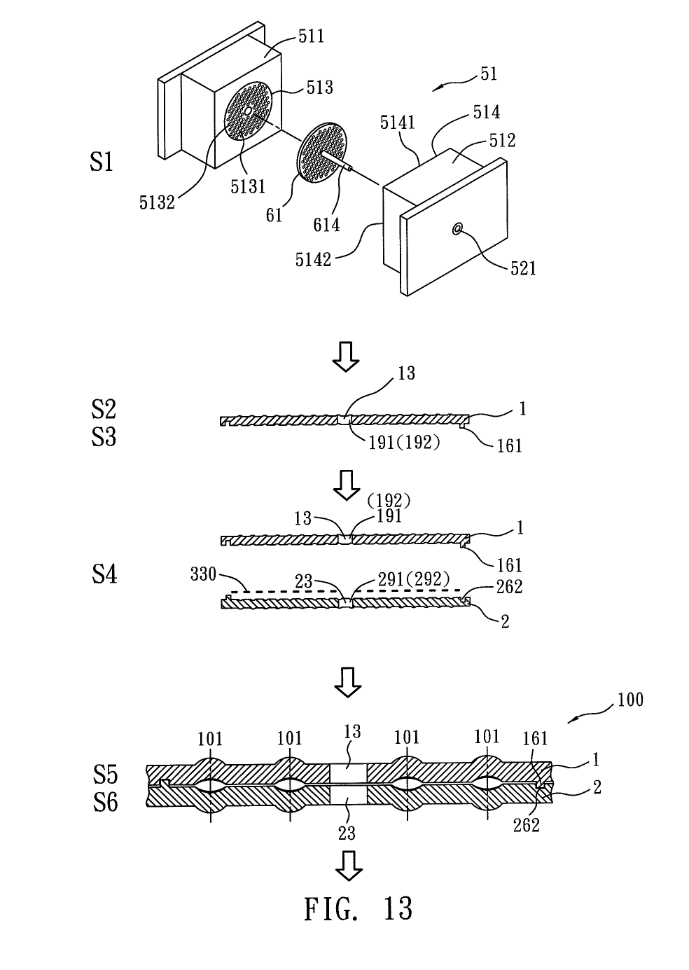

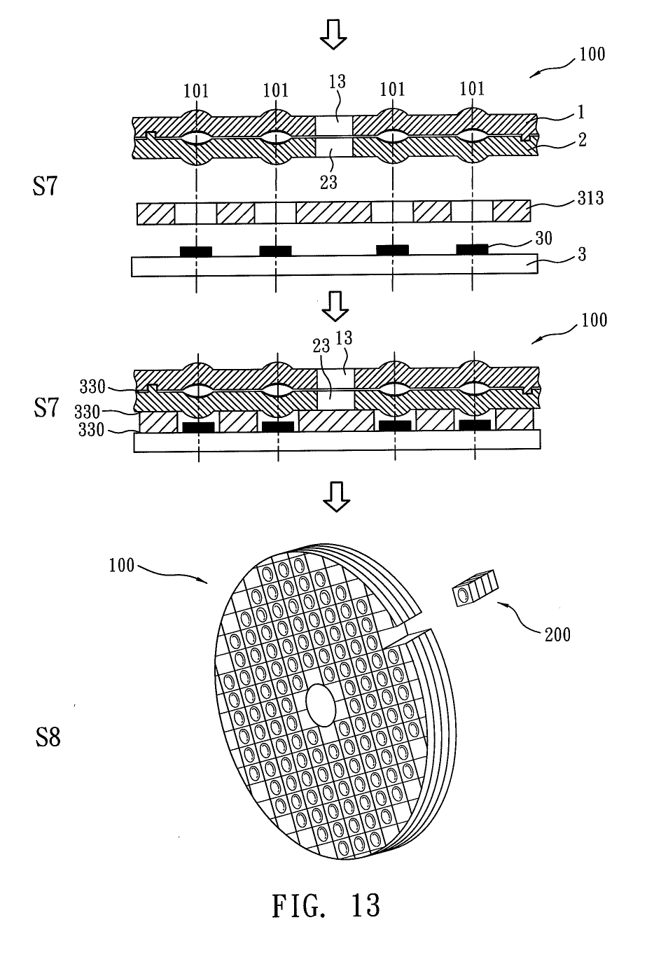

Refer to FIG. 7 and FIG. 11, this embodiment is a stacked disk-shaped optical lens array 100 that includes an alignment through hole 17(27), a disk hole 13 (23) with a guiding structure 192,292 (guiding angle), a first disk-shaped optical lens array 1, and a second disk-shaped optical lens array 2.

The first and the second disk-shaped optical lens arrays 1, 2 are produced by the same method mentioned in the embodiment one and embodiment two. A disk hole 13, 23 thereof is a square with a guiding structure 191, 291 that is a guiding angle and is formed by punching a down sprue stick 614 of a primary product of a disk-shaped optical lens array 61. Moreover, non-optical division of the first disk-shaped optical lens array 1 and of the second disk-shaped optical lens array 2 is arranged with at least one alignment through hole 17(27) corresponding to each other and used as alignment fixtures. In FIG. 7, the two alignment through holes 17(27) are disposed at 90 degrees around the peripheral of the disk-shaped optical lens array but not limited. Refer to FIG. 11, the two alignment through holes 17(27) are arranged at 180 degrees around the peripheral of the disk-shaped optical lens array.

While assembling and stacking, the glue groove 202 of the second disk-shaped optical lens array 2 is coated with glue 330 such as thermosetting glue (but not limited to). Then the first disk-shaped optical lens array 1 and the second disk-shaped optical lens array 2 are put into an assembly fixture 55 for initial alignment. The assembly fixture 55 is arranged with a disk-hole assembly pole 551 whose shape and position are corresponding to those of the guiding angle (192,292) of the disk hole 13, 23. Thus the first and the second disk-shaped optical lens arrays 1, 2 are initially aligned along a disk hole guiding line 104 by the disk-hole assembly pole 551 of the assembly fixture 55. Then by two alignment poles 553 of the assembly fixture 55 respectively being inserted into the alignment through holes 17, 27 of the e first and the second disk-shaped optical lens arrays 1, 2, optical axes of each lens element 10, 20 are aligned with each other, aligned with the optical axis 101. After the glue 330 being cured in an oven, a stacked disk-shaped optical lens array 100 is removed from the assembly fixture 55 and produced. By such precise alignment, stacking and assembling, the assembly time is reduced and the assembling efficiency is improved.

### Embodiment 4

Refer to FIG. 7, this embodiment is a stacked disk-shaped optical lens array 100 that includes a reticle 18(28) as alignment fixture, a disk hole 13 (23) with a guiding structure 192,292 (guiding angle), a first disk-shaped optical lens array 1, and a second disk-shaped optical lens array 2.

The first and the second disk-shaped optical lens arrays 1, 2 are produced by the same method mentioned in the embodiment three. The difference between this embodiment and the above one is in that the non-optical divisions of the first and the second disk-shaped optical lens arrays 1, 2 are respectively are disposed with reticles 18(28) used as alignment fixture. The reticle 18(28) is formed by hair lines and the two reticles 18(28) of this embodiment can be, but not limited to, arranged at 90 degrees around the periphery of the disk-shaped optical lens array 1(2).

While assembling and stacking, similar to the embodiment three, initial alignment is achieved by the disk hole 13(23) and the guiding angle 192 (292). For precise alignment (refer to the embodiment two and FIG. 12), a laser alignment system 57 is used to emit a laser beam 571 passing through the reticles 18, 28. Then adjust the first and the second disk-shaped optical lens arrays 1, 2 so as to make optical axes 101, 201 of each optical lens element 10, 20 align with each other. That means align with the optical axis 101. After curing of the glue 330 and being removed from the assembly fixture 55, a stacked disk-shaped optical lens array 100 that are assembled precisely is obtained.

### Embodiment 5

Refer to FIG. 14, this embodiment is a high-precision stacked lens module 300 used in small-sized mobile phones with cameras. A stacked disk-shaped optical lens array 100 is cut into a plurality of stacked optical lens elements 200 that is assembled with other optical elements and a lens holder so as to form the stacked lens module 300. The stacked lens module 300 consists of a stacked optical lens element 200, a lens holder 301 and other optical elements. In this embodiment the optical elements include a cover glass 311, an aperture 312, two spacers 313, an IR cut glass 314, and an image capture device 30 set on a circuit board 3.

The manufacturing processes of this embodiment are similar to those of the above embodiments. Firstly, produce a stacked disk-shaped optical lens array 100 that are assembled precisely and having a first and a second disk-shaped optical lens arrays 1, 2 glued and fixed by glue 330. The first and the second disk-shaped optical lens arrays 1, 2 respectively have 249 meniscus lens elements 10, 20 as the embodiment two. By the guiding structure and the alignment structure mentioned in above embodiments, optical axes 101, 201 of each lens elements 10, 20 are aligned and assembled precisely. After being cut and divided, 248 stacked optical lens elements 200 are produced (one is unable to be used due to under-size of the periphery), each having two meniscus lens elements 10, 20 aligned with the optical axis 101.

While assembling, the cover glass 311 is mounted into the lens holder 301 firstly. The aperture 312 is glued with the stacked optical lens element 200 and then set into the lens holder 301. For keeping designed air spacing between the IR cut glass 314 and the optical lens element 20, a first spacer 313 is disposed between the stacked optical lens element 200 and the IR cut glass 314. The image capture device 30 is preset on a circuit board 3a. In order to have designed air spacing between the IR cut glass 314 and the image capture device 30, a second spacer 313 is arranged between the IR cut glass 314 and the image capture device 30. By threads between the second spacer 313 and the lens holder 301, the above-mentioned optical elements are fixed. Lastly the image capture device 30 and the circuit board 3a are glued and fixed in the lens holder 301 to produce a stacked lens module 300. The structure of the stacked lens module 300 and the manufacturing method thereof overcomes shortcomings of conventional techniques during which each optical element needs to be adjusted, calibrated and assembled by optical instruments. Moreover, the difficulties in increasing lens resolution due to alignment of optical axes are also reduced.

Furthermore, for cost down and mass production, the stacked lens module 300 of this embodiment can be assembled in another way. As embodiment one, each optical element is produced in an array form such as disk-shaped aperture array, disk-shaped first spacer array, disk-shaped IR cut glass array etc. A plurality of disk-shaped optical element arrays is produced firstly. The disk-shaped optical element arrays are assembled and stacked precisely with the stacked disk-shaped optical lens array 100 of the present invention to form a stacked lens sub-module array. Then the stacked lens sub-module array is cut and divided into several stacked optical lens elements 200 with optical elements, as the embodiment one and the embodiment shown in FIG. 10. The sub-module is mounted into the lens holder 301 at a time to form a stacked lens module 300. The disk-shaped aperture array is formed by 252 opaque plastic plates with through holes. The disk-shaped first spacer array includes 252 opaque plastic plates with preset thickness and through holes. The disk-shaped IR cut glass array is formed by cutting a whole IR filter plate into disk-shaped.

### Embodiment 6

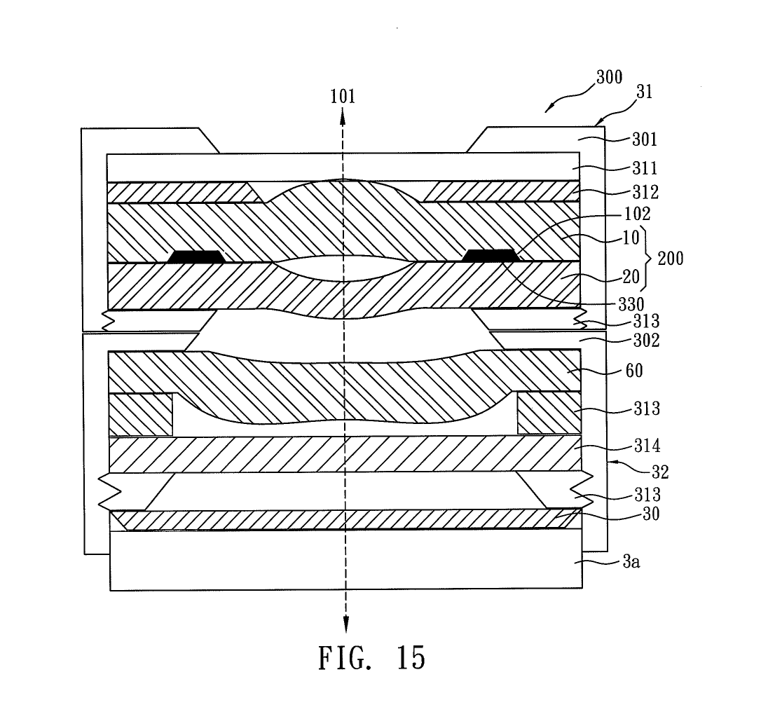

Refer to FIG. 15, this embodiment is a stacked lens module 300 applied to zoom lenses of cameras. In order to provide zooming capability, different optical lens elements are assembled into an optical lens group. The zooming effect is achieved by changing the distance between two optical lens groups. In this embodiment, the stacked lens module 300 is composed of a first optical lens group 31 and a second optical lens group 32. The first optical lens group 31 includes a stacked optical lens element 200, a lens holder 301 and several optical elements. The stacked optical lens element 200 is formed by two optical lens elements 10, 20 while the optical elements include a cover glass 311, an aperture 312 and spacers 313 for fixing each optical element and the lens holder 301. The second optical lens group 32 includes a third plastic lens element 60, a lens holder 302 and several optical elements having two spacers 313, one IR cut glass 314, one image capture device 30 and one circuit board 3a.

The method of manufacturing this embodiment is the same as the one mentioned in the above four embodiments. At first, a stacked optical lens element 200 including two optical lens elements 10, 20 and glue grooves 102 is produced. Then mount a cover glass 311, an aperture 312, the stacked optical lens element 200 into a lens holder 301 to form a first optical lens group 31. A third plastic lens element 60 and a lens holder 302 are also prepared. Next the third plastic lens element 60, a spacer 313, an IR cut glass 314 and another spacer 313 is assembled into the lens holder 302 in turn. A circuit board 3a set with an image capture device 30 is assembled onto the lens holder 302 so as to form a second optical lens group 32.

In use, the first optical lens group 31 is mounted into a lens barrel (not shown in figure). By movement of the first optical lens group 31, the distance between the optical lens groups varies so as to achieve zooming effect. Thereby the stacked lens module 300 is produced easily and quickly. By virtue of mass production, the cost is reduced dramatically.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is :

1. A stacked disk-shaped optical lens array comprising at least two disk-shaped optical lens arrays and each disk-shaped optical lens array having a plurality of optical lens elements;
wherein an optical axis of each optical lens element of the stacked disk-shaped optical lens array is aligned by at least one alignment fixture arranged at the disk-shaped optical lens array and the disk-shaped optical lens arrays are fixed and assembled by glue with a preset interval;
wherein the disk-shaped optical lens array produced by resin injection-compression molding and resin casting process through a center thereof is a disk with a disk hole at a center thereof and the plurality of optical lens elements is arranged in an array; at least glue groove and the at least one alignment fixture are disposed on a periphery of non-optical division of the disk-shaped optical lens array.

2. The device as claimed in claim 1, wherein the disk hole of the disk-shaped optical lens array is with at least one guiding structure.

3. The device as claimed in claim 2, wherein the guiding structure is a guiding notch, a guiding angle or their combinations.

4. The device as claimed in claim 1, wherein the alignment fixture is an alignment pin, an alignment cavity, a collimating lens, a through hole, a reticle or their combinations.

5. The device as claimed in claim 1, wherein a spacer array is arranged between the at least two disk-shaped optical lens arrays and the spacer array is assembled and fixed with adjacent disk-shaped optical lens array by glue for producing designed air spacing.

6. The device as claimed in claim 1, wherein the glue is thermosetting glue that is cured after being heated.

7. The device as claimed in claim 1, wherein the glue is UV glue that is cured after UV radiation.

8. A stacked lens module comprising at least one stacked optical lens element, a lens holder and at least one optical element; wherein the lens holder is used to assemble and fix the stacked optical lens element and the optical element;
wherein the stacked optical lens element is a single element produced by cutting of a stacked disk-shaped optical lens array;
wherein the stacked disk-shaped optical lens array is as claimed in claim 1.

9. The device as claimed in claim 8, wherein the optical element is an optical lens, an aperture, a cover glass, an infrared cut glass, an image capture device, a photoelectric device, a light emitting diode, a printed circuit board of their combinations.

10. A method of manufacturing a stacked disk-shaped optical lens array comprising the steps of:
S1: providing an injection-compression mold having an upper mold and a lower mold respectively with optical molding surfaces; the upper mold and/or the lower mold is disposed with at least one alignment fixture molding surface respectively and a material inlet is arranged at a center of the upper mold or the lower mold;
S2: producing a primary product of disk-shaped optical lens array by resin injection-compression molding and cutting off a down sprue stick of the primary product of a disk-shaped optical lens array to produce a disk-shaped optical lens array; the disk-shaped optical lens array having a plurality of optical lens elements formed on optical division while non-optical division of the disk-shaped optical lens array is arranged with at least one glue groove and at least one alignment fixtures; a disk hole is formed at a center of the disk-shaped optical lens array;
S3: producing another disk-shaped optical lens array by the above steps and this disk-shaped optical lens array is without the glue groove;
S4: coating glue on the glue groove of the two disk-shaped optical lens arrays for connecting and assembling the two disk-shaped optical lens arrays;
S5: aligning optical axes of the two disk-shaped optical lens arrays by the alignment fixture so that the plurality of optical lens elements of the two disk-shaped optical lens arrays is aligned with optical center;
S6: curing the glue to form a stacked disk-shaped optical lens array.

11. The method as claimed in claim 10, wherein in the step of cutting off a down sprue stick of the primary product of a disk-shaped optical lens array, the disk hole and at least one guiding structure are formed on the disk-shaped optical lens array; and
in the step of coating glue on the glue groove of the two disk-shaped optical lens arrays for connecting and assembling the two disk-shaped optical lens arrays, the two disk-shaped optical lens arrays are stacked and assembled by the guiding structure.

12. The method as claimed in claim 10, wherein the method further includes a step of S7: coating non-optical division of the stacked disk-shaped optical lens array with glue for stacking and assembling with at least one optical element array and producing a stacked disk shaped optical lens array with the optical element array after curing of the glue.

13. A method of manufacturing a stacked lens module comprising the steps of:
SS1: providing a stacked disk-shaped optical lens array having a plurality of optical lens elements arranged in an array as claimed in claim 10;
SS2: cutting the stacked disk-shaped optical lens array to get a single stacked optical lens element;
SS3: mounting the stacked optical lens element into a lens holder to be assembled with optical elements so as to produce a stacked lens module.
